(19) United States
(12) Patent Application Publication
(10) Pub. No.: US 2005/0015317 A1
(43) Pub. Date: Jan. 20, 2005

(54) Printing check settlement information at the point of sale

(75) Inventors: Herman Rodriguez, Austin, TX (US); Newton James Smith JR., Austin, TX (US); Clifford Jay Spinac, Austin, TX (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY (US)

(21) Appl. No.: 10/621,944

(22) Filed: Jul. 17, 2003

(51) Int. Cl. G06F 17/60

(52) U.S. Cl. 705/30

(57) ABSTRACT

Methods, systems, and computer program products are described for check settlement, including a merchant's receiving a check from a customer; entering check settlement information as digital data stored in computer memory; and printing the check settlement information on the check. Typical embodiments also include depositing the check and settling the check with no need to repeat the steps of entering and printing the check settlement information. In typical embodiments, check settlement information comprises merchant endorsement information and check-specific information. In such embodiments, entering check settlement information typically includes entering merchant endorsement information before receiving a check and entering check-specific information upon receiving a check.

### BACKGROUND OF THF INVENTION

1. Field of the Invention

The field of the invention is data processing, or, more specifically, methods, systems, and products for printing check settlement information on a check at a point of sale.

2. Description Of Related Art

Money in banking systems consists primarily of ledger entries on the books of banks or other financial institutions. A checking account that records deposits and withdrawals of a customer can be used, via the customer's instructions in the form of a check, to make payments to merchants. Typically, a check is written by a customer, authenticated by signature, and presented to a merchant, who may endorse it with a signature before presenting it to a bank for payment. If the merchant's bank and the consumer's bank are the same, the bank can transfer the funds on its ledgers from the customer's account to the merchant's. If the drawer and the payee accounts are at different banks, the payee's bank presents the check for settlement to the drawer's bank and receives the funds in return through a settlement system. Several private check settlement systems or clearinghouse systems, as well as the Federal Reserve system, provide settlement services in the United States.

A merchant's accepting a paper check as payment for goods or services involves substantial data entry in a point of sale (“POS”) terminal, including, for example:
cashier entry of the check amount into the POS terminal,
cashier entry of the check writer's identification—such as a driver license number and optionally a telephone number, and
entry of the merchant's endorsement information for the bank deposit.

In the United States and Canada, a drawee bank's identification code and drawers' account numbers are encoded in magnetic ink on checks, a so-called ‘MICR encoding.’ In prior art, the check amount and the merchant endorsement information is not recorded by the check writer or the merchant on the check in machine readable form. The check amount is typically hand-written, for example, therefore requiring additional manual data entry during settlement processing for the check.

In a payment processing system, the cost of normal operations is frequently outweighed by the costs associated with error and exception handling. If a typical transaction costs five cents to process, and the manual labor associated with handling errors and exceptions comes to an average of $25 per error, even with an error rate of only two per thousand, error handling costs will equal or exceed normal processing costs. As electronic processing drives down the cost of normal transactions, error handling in the processing of paper checks becomes relatively more significant. Settlement systems must therefore be implemented to very high standards of reliability, and there is an ongoing need for improvement.

### SUMMARY OF THE INVENTION

Methods, systems, and computer program products are described for check settlement, including a merchant's receiving a check from a customer; entering check settlement information as digital data stored in computer memory; and printing the check settlement information on the check. Typical embodiments also include depositing the check and settling the check with no need to repeat the steps of entering and printing the check settlement information.

In typical embodiments, check settlement information comprises merchant endorsement information and check-specific information. In such embodiments, entering check settlement information typically includes entering merchant endorsement information before receiving a check and entering check-specific information upon receiving a check.

In typical embodiments, printing the check settlement information comprises printing the check settlement information in a font used for check settlement. When the font is a MICR font, printing check settlement information typically includes printing the check settlement information in magnetic ink. The font may be an OCR font, and, if so, printing the check settlement information typically includes printing the check settlement information in non-magnetic ink.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating the use of a settlement system in the context of merchants' accepting checks and printing check settlement information on checks presented by customers as payment for goods or services.

FIG. 2 sets forth a block diagram of an exemplary POS terminal or cash register useful according to embodiments of the present invention.

FIG. 3 sets forth a data flow diagram illustrating an exemplary method for check settlement.

### DETAILED DESCRIPTION OF EXEMPLARY EMBODIMENTS

### Introduction

The present invention is described to a large extent in this specification in terms of methods for printing check settlement information on a check at a point of sale. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system, in this case, typically a POS terminal or cash register.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, typically POS terminals or cash registers, nevertheless, alternative embodiments implemented as firmware or even purely as hardware are well within the scope of the present invention.

### Definitions

A “check” is a payment instrument representing a written order from one party (the drawer) to another party (the drawee, normally a bank) requiring the drawee to pay a specified sum on demand to the drawer or to a third party specified by a drawer. Such third parties are called payees, and in this disclosure, payees are often referred to as ‘merchants.’ Drawers are often referred to in this disclosure as ‘customers.’

“Clearance” is the process of transmitting, reconciling, and in some cases, confirming payments orders or check transfer instructions prior to settlement.

A “customer” is any person or entity that presents checks as payment for anything. A “merchant” is any person or entity that accepts checks as payment for anything. Things that can be paid for by check include goods, services, real estate leases, purchases of real estate, software licenses, and other as will occur to those of skill in the art.

“MICR” and “OCR” are designations of machine readable character recognition fonts used in banking and check settlement. MICR fonts are Magnetic Ink Character Recognition fonts, and OCR fonts are Optical Character Recognition fonts. The distinction between them, however, is not absolute. Some banks and settlement systems use magnetic ink for OCR, and MICR fonts can be read optically. The MICR font known as “E-13B” is used most commonly by banks and settlement systems in the US and Canada. The MICR font “CMC-7” is used most in France and some other countries. In still other countries, OCR fonts predominate for banking and check settlement. Here is an example of the MICR font E-13B:
0123456789

[symbol]

The MICR font E-13B was the first font used in automated banking. It contains the digits 0-9 and four special symbols used in banking. The four special symbols are “dash,” “amount,” “on*us,” and “transit.” The E-13B font was originally designed using the heavy black features shown in some symbols so that magnetic pulses could be read clearly, although as mentioned, E-13B can also be read by machines optically with good reliability. MICR fonts and OCR fonts are typically printed with laser printers.

“POS” abbreviates “point of sale.” In this disclosure, ‘POS’ refers to the location of a POS terminal, which is also the location where a merchant's initial data entry regarding a check occurs.

“POS terminal” is a cash register or other automated computing machinery used to administer a commercial transaction at a point of sale. In this disclosure, the terms “POS terminal” and “cash register” are used as synonyms.

A “settlement system” is a centralized processing organization through which banks exchange checks and payment of check amounts. The banks settle for checks exchanged at a designated time based on the rules and procedures of the settlement system. Such a settlement system is sometimes referred to as a “clearing corporation” or a “clearinghouse.”

“Settlement” is the final step in the transfer and payment of a check, involving the actual exchange of check and payment. In a banking transaction, settlement includes the process of recording the debit and credit positions of the parties involved in a transfer of funds. Settlement may occur entirely in a merchant's depository bank, with no recourse to a clearinghouse, when the depository bank is also the drawee bank on a check. That is, the customer and the merchant use the same bank, so that settlement needs only a few accounting entries in the books of one bank, with no need to send the check out to a clearinghouse.

It is useful to further explain the terminology adapted in this disclosure regarding clearance and settlement: Because settlement is the culmination of clearance, which in some cases at least does not require the use of clearinghouse procedures external to a drawee bank, this disclosure generally speaks of settlement as including or implying clearance. That is, this disclosure generally treats settlement as including the use of clearance procedures and therefore speaks generally in terms of settlement, settlement systems, and settlement procedures rather than clearance, clearinghouses, and clearinghouse procedures.

### Printing Check Settlement Information at Point of Sale

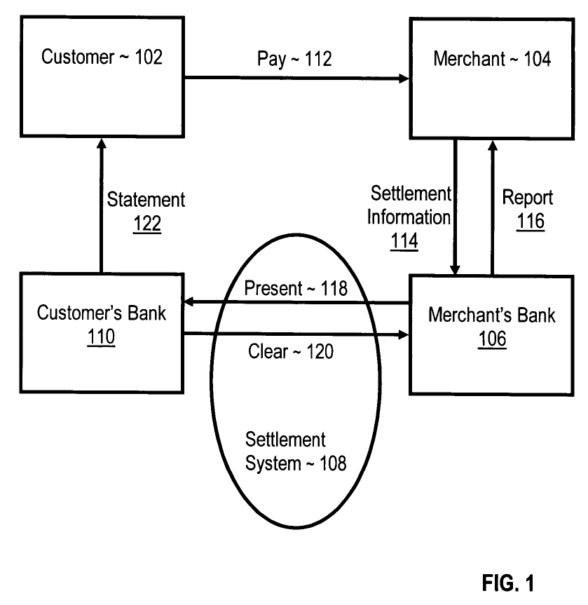

Exemplary embodiments of inventive methods, systems, and computer program products are now explained for printing check settlement information on a check presented by a customer are now explained with referenced to the included drawings, beginning with FIG. 1. In methods according to embodiments of the present invention, a merchant typically is enabled to perform all data entry at the point of sale, all the data entry needed for settlement for both the merchant and for any settlement system used to settle checks. The check settlement information as entered is then printed on the checks in machine readable fonts of the kind used by banks or settlement systems in applicable settlement procedures, that is, MICR fonts or OCR fonts. It is useful to remember that check settlement information, the check amount, additional authentication, merchant data, and so on, typically is entered at POS, although in prior art it was not printed in MICR or OCR on the check, thereby requiring an additional round of data entry for such data when a check is received in a depository bank or a settlement system.

FIG. 1 sets forth a block diagram illustrating the use of a settlement system in the context of merchants' accepting checks and printing check settlement information on checks presented by customers as payment for goods or services. In the example of FIG. 1, a customer (102) pays (112) a merchant (104) for goods or services with a check. The merchant (104) prints settlement information on the check and deposits (114) the check in the merchant's depository bank (106). If the drawee bank on the check is the merchant's bank, that is, if the customer's account is in the same bank used by the merchant (106), then the check can be settled in the merchant bank without recourse to a settlement system. If the drawee bank on the check is not the same as the merchant's bank, then the check is sent to a settlement system (108) for presentment (118) to the drawee bank, the customer's bank (110). The settlement system (108) provides clearance reports (120) to the merchant bank, which in turn provides account reports (116) to the merchant (104). The customer's bank (110) provides account statements (122) to the customer, optionally including copies of cancelled checks.

An important benefit of methods according to embodiments of the present invention is that the need for redundant data entry is greatly reduce or entirely eliminated, because by the time the depository bank (106) or the settlement system (108) receives the check, the correct amount is already printed on the check in the font and ink type used by the depository bank or settlement system to read machine readable data from a paper check. In prior art, the machine readable data read from a check included the drawer's bank identification and the drawer's account number. Now the machine readable information may also include all information needed for clearance and settlement, including the check amount, the payee's bank identification, the payee's bank account number, the payee's endorsement, addition authentication data (drivers license number, phone number), and so on.

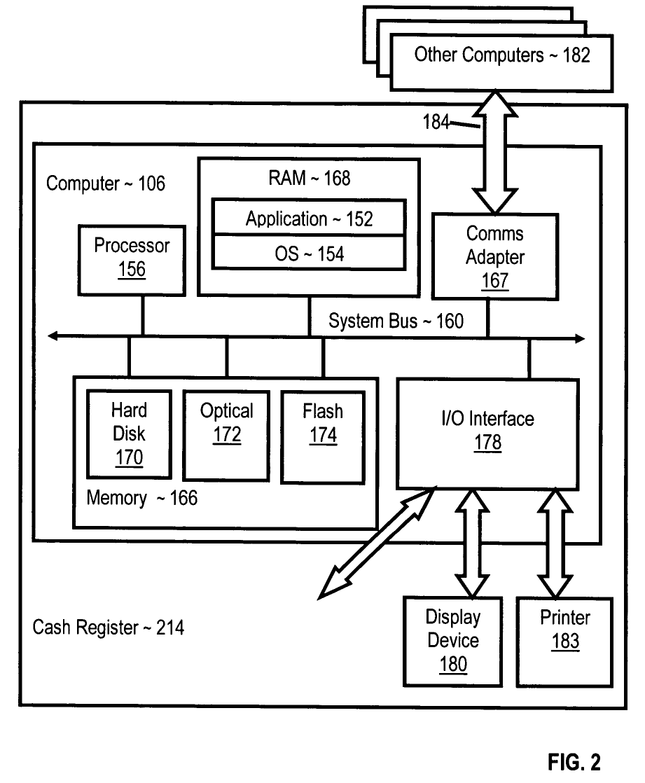

FIG. 2 sets forth a block diagram of an exemplary POS terminal or cash register useful according to embodiments of the present invention. The exemplary cash register of FIG. 2 is implemented largely as automated computing machinery, that is, computer hardware and software useful in systems for printing check settlement information. The cash register of FIG. 2 includes at least one computer processor (156) or ‘CPU’ as well as random access memory (168) (“RAM”). Stored in RAM (168) is an application program (152). Application programs useful in implementing inventive methods of the present invention typically include the software that effects user input of descriptions or identification codes of items or services sold, entry of check amounts, printing of paper receipts describing transactions, and printing of check settlement information on checks, and so on. Computer program products implementing methods of printing settlement information on checks according to embodiments of the present invention, typically include such an application program recorded on a recording medium such as a CD-ROM or EEPROM card for installation on a POS terminal or cash register.

Also stored in RAM (168) in this example is an optional operating system 154. An operating system is a layer of software that controls access for a software applications to computer hardware components, printers, hard drives, and the like. Operating systems useful in cash registers according to embodiments of the present invention include AIX™, Linux, Microsoft NT™, and many others as will occur to those of skill in the art. The operating system in this example is said to be optional because some cash registers' array of computer hardware may be simple enough to operate at the application level with no need for a separate operating system as such.

The cash register (214) of FIG. 2 includes computer memory (166) coupled through a system bus (160) to the processor (156) and to other components of the computer. Computer memory (166) may be implemented as a hard disk drive (170), optical disk drive (172), electrically erasable programmable read-only memory space (‘EEPROM’ or ‘Flash’ memory) (174), or as any other kind of computer memory as will occur to those of skill in the art.

The example cash register (214) of FIG. 2 includes communications adapter 167 implementing couplings for data communications 184 to other computers 182. It is common in merchant establishments having many cash registers, for example, to connect the cash registers through a LAN to a server located locally or remotely across a WAN having applications software for accounting for sales, inventory control, and so on. Communications adapters implement the hardware level of data communications connections through which a cash register may communicate with such a server. Examples of communications adapters include modems for wired dial-up connections, Ethernet (IEEE 802.3) adapters for wired LAN connections, and 802.11b adapters for wireless LAN connections.

The example cash register (214) includes one or more input/output interface adapters (178). Input/output interface adapters implement user-oriented input/output through, for example, software drivers and computer hardware for controlling output to display devices (180) such as display screens, CRTs or liquid crystal displays, as well as user input from user input devices (181) such as pressure sensitive screens for inventory identification and keypads for entry of sales amounts and check amounts. In the example of FIG. 2, the cash register includes a printer (183) coupled to the cash register through the input/output interface adapter (178). Such a printer may be physically integrated into the cash register or implemented as a separate, stand-alone printer connected to the cash register through the input/output interface.

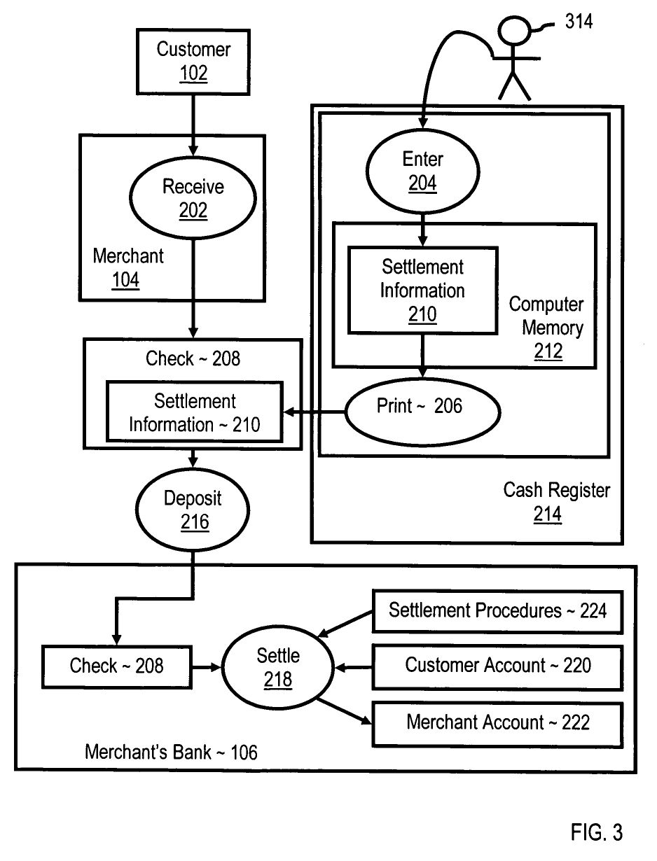

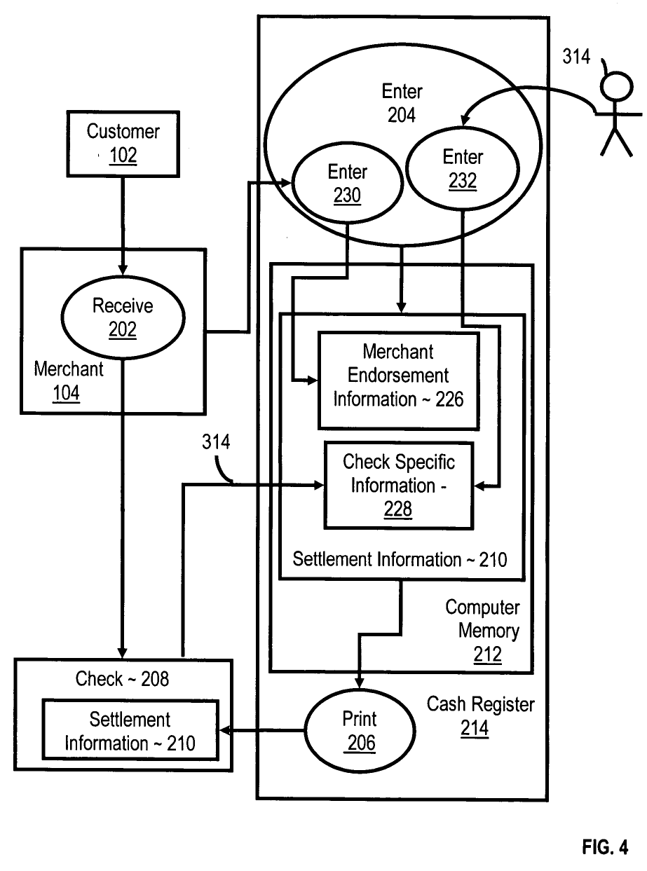

FIG. 3 sets forth a data flow diagram illustrating an exemplary method for check settlement that includes a merchant's receiving (202) a check (208) from a customer (102). Receiving a check often occurs at a point of sale for goods or services, where the check is presented as payment for goods or services. Receiving a check may be carried out by mail, courier, or other receiving means, in addition to accepting a check physically presented in person by a customer actually present at a point of sale.

The method of FIG. 3 also includes entering (204) check settlement information (210) as digital data stored in computer memory (212). The data entry is typically carried out by a merchant or merchant's employee entering settlement information through into computer memory in a cash register (214) located at a point of sale in a merchant establishment. Check settlement information is any information needed for clearance by the merchant's depository bank or settlement system including the check amount, merchant endorsement information (merchant name and account number), and additional customer authentication information such as driver's license number or telephone number.

The method of FIG. 3 also includes printing (206) the check settlement information (210) on the check (208). Printing is generally carried out by use of a printer (not shown). The printer is often a laser printer because they work well with MICR and OCR fonts, but any kind of printer is useful so long as it will properly print the font needed by the depository bank or settlement system. A printer in some embodiments may be integrated directly into the machinery of a cash register. Some printers, however, are provided as separate devices coupled to the cash register through a computer interface capable of accepting from the cash register the check settlement information in electronic form for printing on a check.

Printing (206) the check settlement information (210) typically is carried out by printing the check settlement information in a font used for check settlement. A font used for check settlement is a font used by a settlement system for automated character recognition and data entry. Some settlement systems use a MICR font, and printing check settlement information for checks to be settled by such systems includes printing the check settlement information in magnetic ink. Some settlement systems use an OCR font, and printing check settlement information on checks to be settled by such systems includes printing the check settlement information in non-magnetic ink.

The method of FIG. 3 also includes depositing (216) the check (208) and settling (218) the check with no need to repeat the steps of entering and printing the check settlement information. Depositing (216) the check (208) means depositing the check in the receiving merchant's depository bank (106), a bank where the merchant has an account. Settling (218) the check (208) is carried out according to the depository bank's settlement procedures, generally eventually culminating in a withdrawal of funds from the account (220) of the customer (102) who presented the check as payment for goods or services as well as a corresponding deposit into the merchant's account (222). For purposes of explanation, the customer account (220) is shown in the same bank (106) with the merchant's account (222), although in fact the customer account may be in another bank. If the customer account is in the same bank with the merchant account, then the settlement procedures typically are the bank's. If the customer account is in another bank, then the settlement procedures may include the clearance procedures of a separate settlement system.

FIG. 4 sets forth a data flow diagram illustrating an exemplary method for check settlement that shows more detail regarding check settlement information. In the method of FIG. 4, check settlement information (210) comprises merchant endorsement information (226) and check-specific information (228). Merchant endorsement information (226) may include any information supported or required by applicable settlement procedures, whether of the merchant's bank or a separate settlement system. Merchant endorsement information (226) may include, for example, a merchant's name to be used for printing on a check as an endorsement. Merchant endorsement information (226) may include a depository account number and may also include endorsement limitation language such as “for deposit only” or the like. Similarly, check-specific information (228) may include any check-specific information supported or required by applicable settlement procedures, settlement procedures of the merchant's bank or a separate settlement system.

In the method of FIG. 4, entering (204) check settlement information (210) includes entering (230) merchant endorsement information (226) before receiving (202) a check. Also in the method of FIG. 4, entering (204) check settlement information (210) includes entering (232) check-specific information (228) upon receiving a check. Merchant endorsement information (226) is distinguished generally from check-specific information (228) in that merchant endorsement information is generally printed with the same form and content on many checks.

Because merchant endorsement information is generally unchanged from check to check, it is usefully entered once in configuring a cash register and stored in non-volatile memory such as magnetic memory or EEPROM (electrically erasable programmable read only memory or ‘flash memory,’ as it is called). Check-specific information is typically different for each check and is therefore typically entered only when a check is received from a customer as payment for goods or services. Examples of check-specific information include the amount for which a check is drawn, supplemental authentication information such as a customer's driver's license number, customer address, telephone number, and other information as may be supported or required by applicable settlement procedures.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for check settlement, the method comprising:
a merchant's receiving a check from a customer;
entering check settlement information as digital data stored in computer memory; and
printing the check settlement information on the check.

2. The method of claim 1 further comprising depositing the check and settling the check with no need to repeat the steps of entering and printing the check settlement information.

3. The method of claim 1 wherein check settlement information comprises merchant endorsement information and check-specific information.

4. The method of claim 1 wherein entering check settlement information comprises entering merchant endorsement information before receiving a check and entering check-specific information upon receiving a check.

5. The method of claim 1 wherein printing the check settlement information comprises printing the check settlement information in a font used for check settlement.

6. The method of claim 5 wherein the font is a MICR font, and printing the check settlement information comprises printing the check settlement information in magnetic ink.

7. The method of claim 5 wherein the font is an OCR font, and printing the check settlement information comprises printing the check settlement information in non-magnetic ink.

8. A system for check settlement, the system comprising:
means for entering check settlement information as digital data stored in computer memory; and
means for printing the check settlement information on the check.

9. The system of claim 8 further comprising means for depositing the check and means for settling the check with no need to repeatedly utilize the means for entering and means for printing the check settlement information.

10. The system of claim 8 wherein check settlement information comprises merchant endorsement information and check-specific information.

11. The system of claim 8 wherein means for entering check settlement information comprises means for entering merchant endorsement information before receiving a check and means for entering check-specific information upon receiving a check.

12. The system of claim 8 wherein means for printing the check settlement information comprises means for printing the check settlement information in a font used for check settlement.

13. The system of claim 12 wherein the font is a MICR font, and means for printing the check settlement information comprises means for printing the check settlement information in magnetic ink.

14. The system of claim 12 wherein the font is an OCR font, and means for printing the check settlement information comprises means for printing the check settlement information in non-magnetic ink.

15. A computer program product for check settlement, the computer program product comprising:
a recording medium;
means, recorded on the recording medium, for entering check settlement information as digital data stored in computer memory; and
means, recorded on the recording medium, for printing the check settlement information on the check.

16. The computer program product of claim 15 further comprising means, recorded on the recording medium, for depositing the check and means, recorded on the recording medium, for settling the check with no need to repeatedly utilize the means for entering and means for printing the check settlement information.

17. The computer program product of claim 15 wherein check settlement information comprises merchant endorsement information and check-specific information.

18. The computer program product of claim 15 wherein means for entering check settlement information comprises means, recorded on the recording medium, for entering merchant endorsement information before receiving a check and means, recorded on the recording medium, for entering check-specific information upon receiving a check.

19. The computer program product of claim 15 wherein means for printing the check settlement information comprises means, recorded on the recording medium, for printing the check settlement information in a font used for check settlement.

20. The computer program product of claim 19 wherein the font is a MICR font, and means for printing the check settlement information comprises means, recorded on the recording medium, for printing the check settlement information in magnetic ink.
